(19) United States
(12) Patent Application Publication
(10) Pub. No.: US 2026/0184012 A1
(43) Pub. Date: Jul. 2, 2026

(54) MULTI-MATERIAL POWDER FUSION

(71) Applicant: INTERNATIONAL BUSINESS MACHINES CORPORATION, Armonk, NY (US)

(72) Inventors: Martin G. Keen, Cary, NC (US); Sarbajit Kumar Rakshit, Kolkata (IN); Jeremy R. Fox, Georgetown, TX (US); Carolina Garcia Delgado, Zapopan (MX)

(21) Appl. No.: 19/008,212

(22) Filed: Jan. 2, 2025

(51) Int. Cl. B29C 64/153; B22F 10/28; B22F 10/38; B22F 12/52; B22F 12/90; B29C 64/218; B29C 64/255; B29C 64/336; B33Y 10/00; B33Y 30/00; B33Y 70/10

(52) U.S. Cl. CPC B29C 64/153; B22F 10/28; B22F 10/38; B22F 12/52; B22F 12/90; B29C 64/218; B29C 64/255; B29C 64/336; B33Y 10/00; B33Y 30/00; B33Y 70/10; B22F 2998/10

(57) ABSTRACT

Methods and systems for powder fusion include dispensing a first powder on a powder fusion platform. A second powder is dispensed on the powder fusion platform. The first powder and the second powder are applied to a powder bed of the powder fusion platform using a roller that pushes the first powder and the second powder at the same time. The first powder and the second powder are fused, using an energy source, to form a three-dimensional structure.

### BACKGROUND

The present invention generally relates to additive manufacturing and, more particularly, to powder fusion.

Powder bed fusion is an additive manufacturing technique that deposits a fine layer of powder material on a build platform. This layer of powder is exposed to a high-intensity energy source, such as a laser or electron beam, which causes the powder to melt or sinter. Successive layers are added in a similar way to progressively build up a solid object.

### SUMMARY

A powder fusion method includes dispensing a first powder on a powder fusion platform. A second powder is dispensed on the powder fusion platform. The first powder and the second powder are applied to a powder bed of the powder fusion platform using a roller that pushes the first powder and the second powder at the same time. The first powder and the second powder are fused, using an energy source, to form a three-dimensional structure.

A powder fusion system includes a powder fusion platform. A powder bed includes a top surface which moves vertically with respect to a top surface of the powder fusion platform. A roller applies a first powder and a second powder to the powder bed. An energy source fuses the first powder and the second powder on the powder bed into a three-dimensional object.

A powder fusion system includes a powder fusion platform. A powder bed that a top surface which moves vertically with respect to a top surface of the powder fusion platform. A first dispenser holds a first powder and a second dispenser holding a second powder. A roller applies the first powder and the second powder to the powder bed. An energy source fuses the first powder and the second powder on the powder bed into a three-dimensional object. The system includes a processor set, one or more computer-readable storage media, and program instructions stored on the one or more computer-readable storage media to cause the processor to perform operations. The operations include determining a powder pattern based on a design for the three-dimensional structure that determines placement of the first powder and the second powder the powder fusion platform, dispensing the first powder and the second powder in accordance with the powder pattern, triggering application of the first powder and the second powder to the powder bed using the roller, and triggering fusion of the first powder and the second powder using the energy source.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a powder fusion system that uses a roller to distribute powder over a movable powder bed, in accordance with an embodiment of the present invention;

FIG. 2 is a diagram of a powder fusion system that fuses multiple powder materials, in accordance with an embodiment of the present invention;

FIG. 3 is a diagram of a powder fusion system that fuses multiple powder materials, in accordance with an embodiment of the present invention;

FIG. 4 is a diagram of a powder fusion system that fuses multiple powder materials, in accordance with an embodiment of the present invention;

FIG. 5 is a top-down view of a powder fusion platform that shows how different powder materials can be combined, in accordance with an embodiment of the present invention;

FIG. 6 is a cross-sectional view of a powder-distributing roller that has surface features, in accordance with an embodiment of the present invention;

FIG. 7 is a block/flow diagram of a method for performing powder fusion, in accordance with an embodiment of the present invention; and

FIG. 8 is a block diagram of a computing environment that can perform powder pattern determination, in accordance with an embodiment of the present invention.

### DETAILED DESCRIPTION

While powder fusion is a powerful technique for the fabrication of three-dimensional objects, it can be difficult to create objects from different types of powder. Without careful control of powder application, material is wasted, costs go up, and the manufacturing process is slowed. The present embodiments employ a roller to apply powder material. The roller is designed to precisely dispense and blend powder materials, increasing efficiency, reducing waste, and fabricating high-quality, cost-effective, multi-material three-dimensional objects.

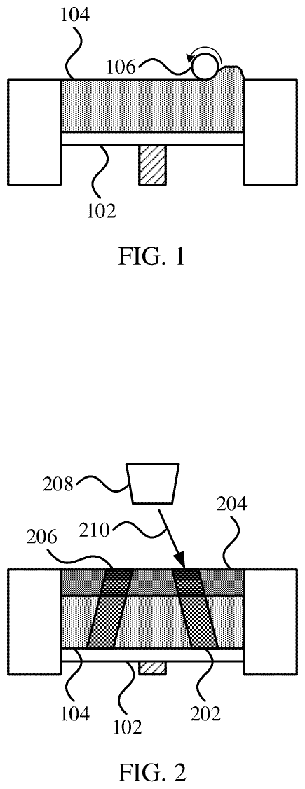

Referring now to FIG. 1, a diagram of a powder bed fusion apparatus and process is shown. A movable powder bed 102 is shown with a first powder 104 on it. The movable powder bed 102 can be raised and lowered through the course of a fabrication process to accommodate successive layers of powder. The first powder 104 is applied using a roller or scraper 106, which pushes across the powder bed 102 to evenly distribute the powder material. Excess material can be brushed off. The first powder 104 may be stored in a powder cartridge or dispenser (not shown) that holds powder material and pushes it up from below so that the roller 106 can then push the powder material across the movable powder bed 102. Multiple such powder cartridges may be used, with each storing a different powder material.

Referring now to FIG. 2, a diagram of a powder bed fusion apparatus and process is shown. An energy source 208 applies energy 210 using, e.g., a laser, electron beam, or any other appropriate directional energy delivery mechanism. When the energy 210 hits the first powder 104, the energy 210 melts or sinters the powder material to create a solid first structure 202 from a first material. Areas that are not touched by the energy 210 remain in powder form. In some cases a scanning mirror may be used to direct the energy 210 to an appropriate location of the movable powder bed 102. In some cases a heater, such as an infrared heater, may be used to keep the powder material at a consistent temperature before the energy 210 is applied.

The movable powder bed 102 then lowers, creating space above the first powder 104. The difference in height for the movable powder bed 102 may be any appropriate distance, in some cases as little as a few micrometers. A second powder 204 is deposited and is spread over the movable powder bed 102, for example using the roller or scraper 106. When the energy source 208 applies the energy 210 to the second powder 204, the energy 210 melts or sinters the powder material to create a second structure 206 from a second material. In areas where the second structure 206 contacts the first structure 202, they may be joined into a single structure that is formed from multiple materials. This process repeats as needed, with any appropriate number of materials, to fabricate a finished three-dimensional object.

The first powder 104 and the second powder 204 may be formed from a same material or from different materials. In some cases, the first powder 104 and/or the second powder 204 may be formed from a composite of multiple materials. The resulting first structure 202 and second structure 206 will have materials determined by the materials of the respective first powder 104 and second powder 204. In some cases, one or more of the powder materials may be formed from a metallic material, such as aluminum, cobalt chrome, copper, steel, titanium, nickel, and composites thereof. In some cases, one or more of the powder materials may be formed from a polymer material, such as nylon, glass-filled nylon, mineral-filled nylon, polypropylene, and thermoplastic polyurethane. In some cases, one or more of the powder materials may be formed from a combination, such as aluminum-filled polyamide, carbon-fiber filled polyamide, and glass-filled polyamide.

The roller 106 may roll counter to the motion of the roller across the movable powder bed 102. The roller 106 spreads powder material across the movable powder bed 102. In some cases the roller 106 may include chambers that carry a second powder to selectively dispense over the powder bed 102.

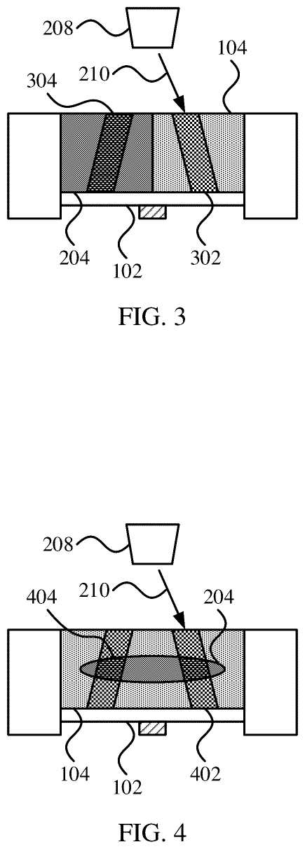

Referring now to FIG. 3, a diagram of a powder bed fusion apparatus and process is shown. In some embodiments, instead of simply applying the second powder 204 on a separate vertical layer as shown above, the first powder 104 and the second powder 204 may be applied together on one or more layers. This can produce regions on a horizontal plane that have different materials, for example producing a first structure 302 from the first powder 104 and a second structure 304 from the second powder 204.

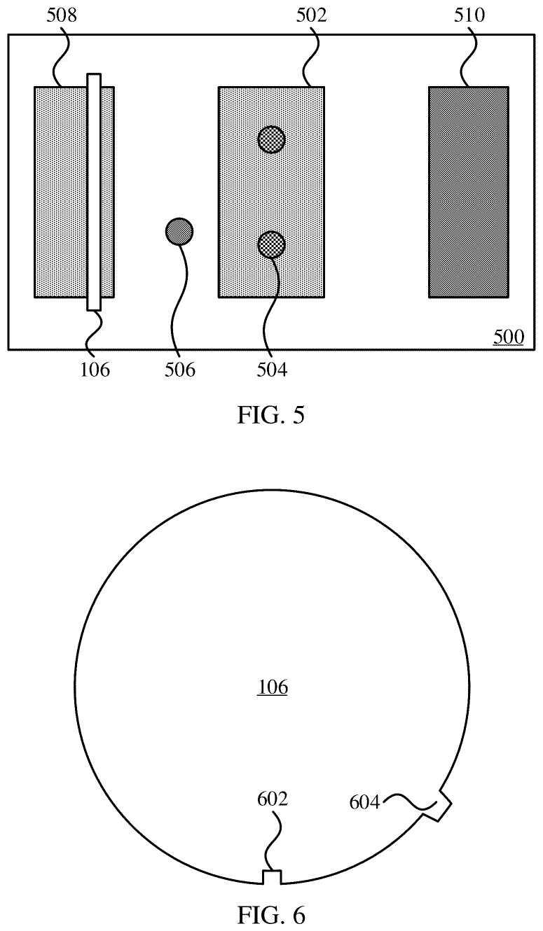

Referring now to FIG. 4, a diagram of a powder bed fusion apparatus and process is shown. In some embodiments, the second powder 204 may be added to a mass of first powder 104 as the material is spread by the roller 106. The second powder 204 may then be distributed across a horizontal layer and may blend with the first powder 104. The result may be structures 402 that are primarily composed of a first material but that include regions 404 composed of a second material, or of a composite of materials.

Referring now to FIG. 5, a top-down view of a powder fusion platform 500 is shown. A powder bed 502 is shown, filled with a first powder. Previously fused structures 504 are shown in the powder bed 502. A first powder reservoir 508 includes the first powder and a second powder reservoir 510 includes a second powder having a different material from the first powder. The roller 106 moves across the platform 500, pushing powder from one of the reservoirs onto the powder bed 502.

In addition to moving material from the first powder reservoir 508 or the second powder reservoir 510, additional powder 506 may be added to the platform between the roller 106 and the powder bed 502. For example, the additional powder 506 may be a second powder. As the roller 106 moves first powder from the first powder reservoir 508 and crosses the additional powder 506, the additional powder 506 may blend with the first powder before it reaches the powder bed 502. The blended powder may then be distributed across the powder bed 502.

In some cases the first powder reservoir 508 and/or the second powder reservoir may be divided into sections with different respective powders. The powder will remain generally separated, with some mixing at the border, and will create distinct powder regions on the powder bed 502. In some cases the roller 106 may be used to move powder from both powder reservoirs. Additionally, it should be understood that any appropriate number of powder reservoirs, with any appropriate number of distinct powder materials, may be used.

The additional powder 506 may be placed to achieve a particular placement of the blend of powder within the finished product. For example, the placement of the additional powder 506 on the platform 500 may correspond to the use of the second powder material in a design for the finished product.

Referring now to FIG. 6, a cross-sectional view of the roller 106 is shown. The roller 106 may include surface features, including depressions 602 and/or protrusions 604. The presence of these surface features can be used to manipulate the powder that is being pushed by the roller 106. For example, a protrusion 604 may be used to minimize an amount of powder in a particular location by clearing away a spot corresponding to the protrusion 604. Similarly a depression 602 can cause additional powder to remain in a particular location. In some cases the roller 106 may include only depressions 602, in some cases the roller 106 may include only protrusions 604, and in some cases the roller 106 may include both.

In some cases the roller 106 counter-rotates as it moves across the powder fusion platform 500. As an example of counter-rotation, if the illustrated roller 106 were moving rightward across the page, then counter-rotation would have it rotating counter-clockwise so that it pushes powder material in front of it. In some cases the roller 106 rotates in a direction aligned with its motion. As an example of aligned rotation, if the illustrated roller 106 were moving rightward across the page, then aligned rotation would have it rotating clockwise.

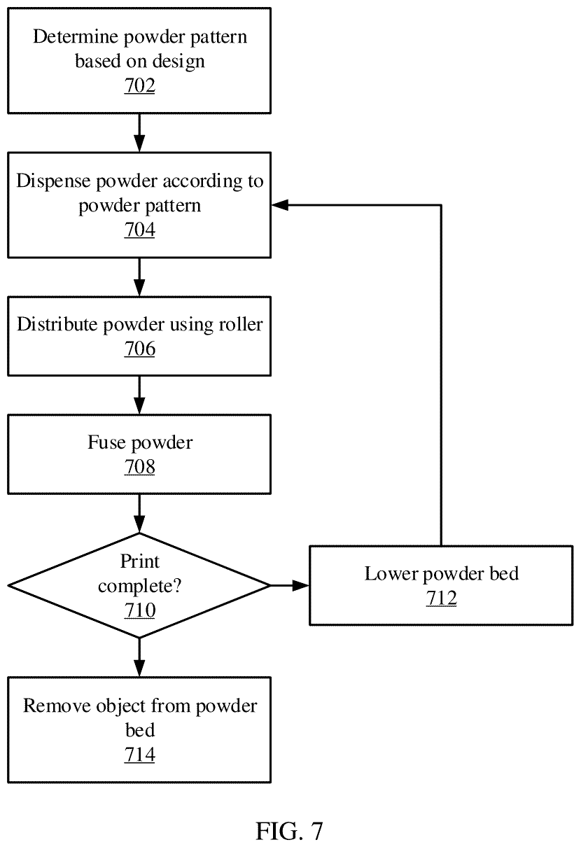

Referring now to FIG. 7, a method of performing powder fusion is shown. Block 702 determines a powder pattern that is based on a design for a three-dimensional object. The design may indicate the parts of the three-dimensional object are formed from particular materials. The powder pattern includes a distribution of powder materials on a powder bed and may further include a distribution of the powder materials on the powder fusion platform, arranged so that the powder materials will arrive in the correct positions on the powder bed when pushed by the roller.

Block 704 dispenses the powder according the powder material. This may include automatically dispensing powder from a powder cartridge or by manually placing powder on the surface of the powder fusion platform. Block 706 distributes the powder using the roller, which pushes the powder onto the powder bed. Block 708 then uses the energy source to fuse the powder, for example by melting or sintering, to create a top layer of the in-progress three-dimensional object.

Block 710 determines whether the print is complete. If not, block 712 causes the powder bed to lower relative to the top surface of the powder fusion platform, creating additional space above the powder bed for new powder. Processing then returns to block 704, so that additional powder is dispensed, distributed, and fused. The positioning of the first powder and the second powder may differ from one repetition to the next, so that the composition of the fused object may change along its height. This process repeats until block 710 indicates that the print is finished, at which point the finished three-dimensional object may be removed from the powder bed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as powder pattern determination 819, triggering the hardware components described above to perform various tasks. In addition to block 200, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 200, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

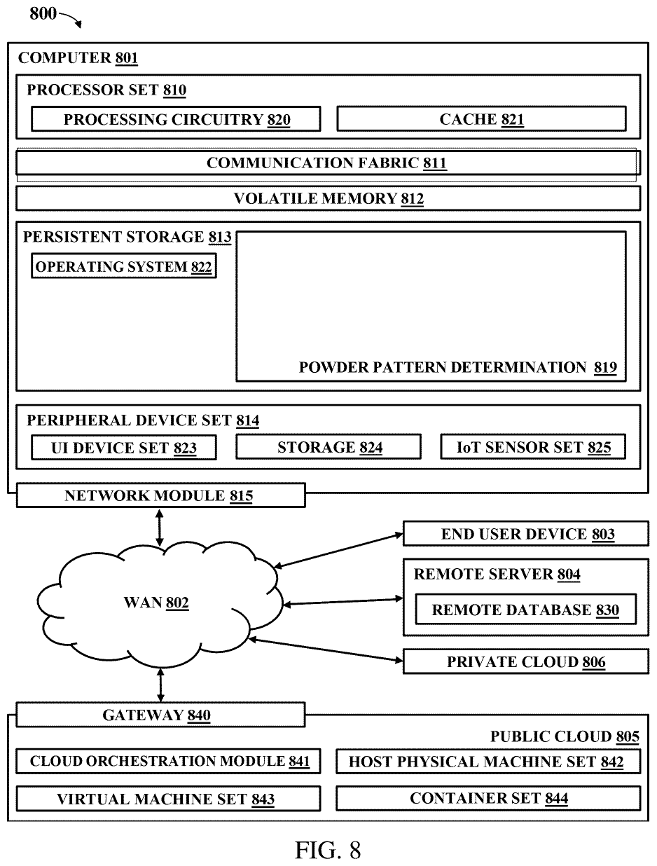

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 200 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815. WAN 802 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of multi-material powder fusion (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for powder fusion, comprising:
dispensing a first powder on a powder fusion platform;
dispensing a second powder on the powder fusion platform;
applying the first powder and the second powder to a powder bed of the powder fusion platform using a roller that pushes the first powder and the second powder at the same time; and
fusing the first powder and the second powder, using an energy source, to form a three-dimensional structure.

2. The method of claim 1, wherein the first powder includes a first material and wherein the second powder includes a second material distinct from the first material.

3. The method of claim 1, wherein the first powder is dispensed from a powder cartridge and wherein the second powder is dispensed on a surface of the powder fusion platform between the powder cartridge and the powder bed.

4. The method of claim 1, wherein applying the first powder and the second powder causes the first powder to blend with the second powder.

5. The method of claim 1, wherein the roller includes a depression or protrusion on its surface.

6. The method of claim 1, wherein applying the first powder and the second powder includes pushing the first powder and the second powder into separate regions of the powder bed.

7. The method of claim 1, wherein the roller counter-rotates when applying the first powder and the second powder.

8. The method of claim 1, further comprising determining a powder pattern based on a design for the three-dimensional structure that determines placement of the first powder and the second powder the powder fusion platform.

9. The method of claim 1, further comprising:
lowering a level of the powder bed relative to the powder fusion platform; and
repeating deposition of the first powder, deposition of the second powder, applying the first powder and the second powder to the powder bed, and fusing the first powder and second powder after lowering the level of the powder bed, wherein the second powder is deposited at a different position of the powder fusion platform.

10. A powder fusion system, comprising:
a powder fusion platform;
a powder bed that includes a top surface which moves vertically with respect to a top surface of the powder fusion platform;
a first powder;
a second powder;
a roller to apply the first powder and the second powder to the powder bed; and
an energy source to fuse the first powder and the second powder on the powder bed into a three-dimensional object.

11. The system of claim 10, wherein the first powder includes a first material and wherein the second powder includes a second material distinct from the first material.

12. The system of claim 10, further comprising a powder cartridge that dispenses the first powder, wherein the second powder is positioned on a surface of the powder fusion platform between the powder cartridge and the powder bed.

13. The system of claim 10, wherein the roller causes the first powder to blend with the second powder.

14. The system of claim 10, wherein the roller includes a depression or protrusion on its surface.

15. The system of claim 10, wherein the roller counter-rotates when applying the first powder and the second powder.

16. A powder fusion system, comprising:
a powder fusion platform;
a powder bed that includes a top surface which moves vertically with respect to a top surface of the powder fusion platform;
a first dispenser holding a first powder;
a second dispenser holding a second powder;
a roller to apply the first powder and the second powder to the powder bed;
an energy source to fuse the first powder and the second powder on the powder bed into a three-dimensional object;
a processor set;
one or more computer-readable storage media; and
program instructions stored on the one or more computer-readable storage media to cause the processor to perform operations comprising:
determining a powder pattern based on a design for the three-dimensional structure that determines placement of the first powder and the second powder the powder fusion platform;
dispensing the first powder and the second powder in accordance with the powder pattern; and
triggering application of the first powder and the second powder to the powder bed using the roller; and
triggering fusion of the first powder and the second powder using the energy source.

17. The system of claim 16, wherein the first powder includes a first material and wherein the second powder includes a second material distinct from the first material.

18. The system of claim 16, wherein the roller includes a depression or protrusion on its surface.

19. The system of claim 16, wherein the roller counter-rotates when applying the first powder and the second powder.

20. The system of claim 16, wherein the operations further include:
triggering a lowering of a level of the powder bed relative to the powder fusion platform; and
repeating deposition of the first powder, deposition of the second powder, applying the first powder and the second powder to the powder bed, and fusing the first powder and second powder after lowering the level of the powder bed, wherein the second powder is deposited at a different position of the powder fusion platform.
